(19) United States
(12) Patent Application Publication
(10) Pub. No.: US 2025/0321352 A1
(43) Pub. Date: Oct. 16, 2025

(54) INFORMATION PROCESSING APPARATUS, INFORMATION PROCESSING METHOD, AND COMPUTER PROGRAM PRODUCT

(71) Applicant: KABUSHIKI KAISHA TOSHIBA, Tokyo (JP)

(72) Inventors: Topon PAUL, Kawasaki (JP); Vidhisha REDDY, Bangalore (IN); Sai Prem Kumar AYYAGARI, Bangalore (IN); Ryusei SHINGAKI, Setagaya (JP); Kaneharu NISHINO, Kawasaki (JP)

(73) Assignee: KABUSHIKI KAISHA TOSHIBA, Tokyo (JP)

(21) Appl. No.: 19/055,729

(22) Filed: Feb. 18, 2025

(30) Foreign Application Priority Data
Apr. 10, 2024 (JP) 2024-063340

(51) Int. Cl. G01W 1/00; G06N 20/00

(52) U.S. Cl. CPC G01W 1/00; G06N 20/00

(57) ABSTRACT

According to one embodiment, an information processing apparatus includes one or more processors. The processors determine weights by m determination methods (m is an integer more than or equal to 2). Each determination method is a method using training data sets, each set including an explanatory variable and a visibility value as an objective variable, to determine the weights for the visibility values. The m determination methods includes a first determination method of determining to assign a larger weight to the training data set including a first visibility value than to other visibility values. The first visibility value occurs with lower frequency than the other visibility values. The processors train m forecast models configured to forecast the visibility values by inputting the at least one explanatory variable. The m forecast models are trained by using the training data sets assigned with the weights determined by the m determination methods.

### CROSS-REFERENCE TO RELATED APPLICATIONS

This application is based upon and claims the benefit of priority from Japanese Patent Application No. 2024-063340, filed on Apr. 10, 2024; the entire contents of which are incorporated herein by reference.

### FIELD

Embodiments described herein relate generally to an information processing apparatus, an information processing method, and a computer program product.

### BACKGROUND

In a traffic control system, visibility forecasting is performed by utilizing weather data in order to secure the safety of road and air traffic.

In conventional visibility forecasting, through a machine learning technique that uses weather data including data indicating measured visibility as a training data set, a forecast model is trained to minimize the overall forecasting error.

However, the conventional techniques sometimes fail in training a forecast model capable of forecasting visibility with high accuracy.

### BRIEF DESCRIPTION OF THE DRAWINGS

FIG. 1 is a diagram illustrating an example of visibility data;

FIG. 2 is a block diagram of an information processing apparatus according to a first embodiment;

FIG. 3 is a diagram illustrating an example of input data for training;

FIG. 4 is a diagram for explaining a specific example of selection processing;

FIG. 5 is a diagram for explaining a specific example of selection processing;

FIG. 6 is a diagram for explaining a specific example of the training processing;

FIG. 7 is a diagram for explaining a specific example of forecasting processing;

FIG. 8 is a diagram for explaining a specific example of training processing for a probabilistic model;

FIG. 9 is a flowchart of training processing in the first embodiment;

FIG. 10 is a flowchart of forecasting processing in the first embodiment;

FIG. 11 is a flowchart of probability training processing in the first embodiment;

FIG. 12 is a diagram illustrating an example of a training data set to be used in the training processing of a model;

FIG. 13 is a diagram illustrating an example of data to be used in forecasting processing by the model;

FIG. 14 is a block diagram illustrating the configuration of an information processing apparatus according to a second embodiment; and

FIG. 15 is a diagram illustrating the hardware configuration of the information processing apparatus according to the first or the second embodiment.

### DETAILED DESCRIPTION

An information processing apparatus according to one embodiment includes one or more hardware processors. The hardware processors are configured to determine weights by m mutually different determination methods (m is an integer greater than or equal to 2). Each determination method is a method using training data sets, each set including at least one explanatory variable and a visibility value as an objective variable, to determine the weights for the visibility values included in the training data sets. The m determination methods include a first determination method of determining to assign a larger weight to the training data set including a first visibility value than to other visibility values. The first visibility value occurs with lower frequency than the other visibility values. The hardware processors are configured to train m forecast models configured to forecast the visibility values by inputting the at least one explanatory variable. The m forecast models are trained by using the training data sets assigned with the weights determined by the m determination methods.

Hereinafter, embodiments of an information processing apparatus according to the present invention will be described in detail with reference to the accompanying drawings.

The conventional art sometimes failed in training a forecast model capable of forecasting visibility with high accuracy, as described above. One of the reasons is that data indicating visibility has the following features.
(F1) The frequency of occurrence of values of visibility (hereinafter referred to as “visibility values”) is biased. For example, a small value of visibility (a low visibility value) occurs with lower frequency than a large value of visibility (a high visibility value).
(F2) An upper limit is defined for the data. For example, as for visibility value data on visibility values to be used for aircraft, values exceeding a certain value (for example, 10 km) are sometimes excluded in accordance with flight altitude limitations and other factors. Since the data has the defined upper limit, the possibility of a high visibility value close to the upper limit occurring with higher frequency, namely, the possibility of the above described situation (F1) is increased.

The visibility value is a standard of how far away an object can be seen and is expressed by, for example, the maximum distance at which an object can be seen with the naked eye. In the following, data indicating the visibility value are sometimes referred to as visibility data. A scale for the visibility data is sometimes changed in accordance with the use. For example, visibility at human eye level is several hundred meters, whereas visibility at aircraft level is several kilometers.

In the conventional art, by using the visibility data having the above-mentioned features, a forecast model is trained to minimize an overall forecast error. Therefore, a high visibility value occurring with high frequency can be forecasted with high accuracy, meanwhile a low visibility value occurring with low frequency cannot be forecasted with high accuracy in some cases.

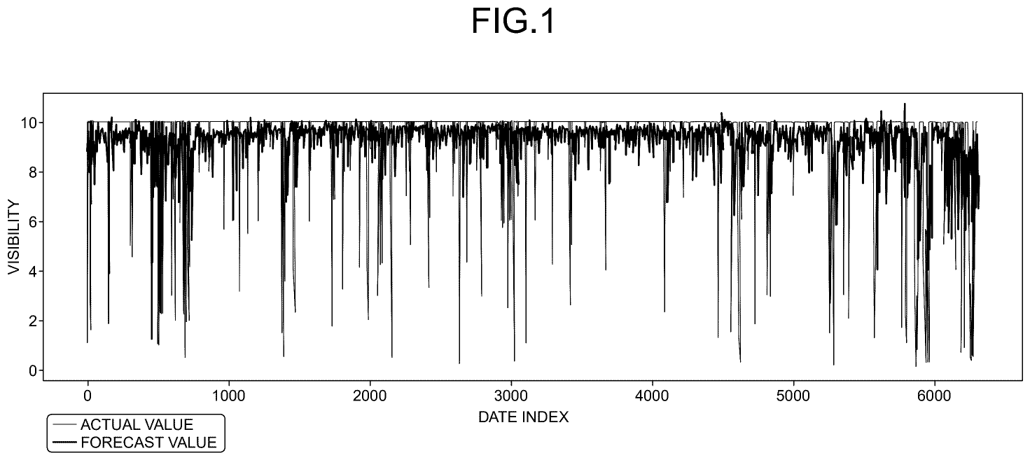

FIG. 1 is a diagram illustrating an example of visibility data. In FIG. 1, visibility values are divided into actual values and forecast values (bold line), and how the visibility values change with time is illustrated. The forecast values are examples of visibility values forecasted by the conventional art.

In the example in FIG. 1, visibility values exceeding the upper limit of 10 are excluded. Moreover, the number of pieces of data on low visibility values of 3 or less, for example, is smaller than the number of pieces of data on high visibility values. In other words, the frequency of occurrence of visibility values is biased. Therefore, as for forecast values by the conventional art, high visibility values are forecasted with relatively high accuracy, meanwhile forecasting of low visibility values has been unsuccessful.

Different phenomena (factors) that affect visibility sometimes occur at different places (regions). For example, PM2.5 in China, dense fog in India, and snowstorms in Japan often cause poor visibility (a decrease in visibility value). Therefore, in the case of forecasting visibility by using weather data, it is desirable to select a more appropriate factor for a forecast target region and use the selected factor as an explanatory variable for the forecasting of visibility (objective variable).

### First Embodiment

An information processing apparatus of a first embodiment trains (builds) two forecast models including a forecast model for more accurately forecasting a visibility value occurring with low frequency (for example, a low visibility value). The information processing apparatus of the present embodiment forecasts a visibility value in a forecast target period by applying data for forecasting (forecast data) to the trained forecast models. Moreover, the information processing apparatus of the present embodiment selects at least one factor (visibility factor) effective for forecasting of visibility from a plurality of factors (a plurality of types of weather data), and performs training of the forecast models by using the selected visibility factor and performs forecasting using the forecast models.

In the present embodiment, the two forecast models are trained as described above, and forecasting processing is executed using the two forecast models. The number m of the forecast models is not limited to 2, but may be 3 or more. A configuration in which m is 3 or more will be described in a second embodiment.

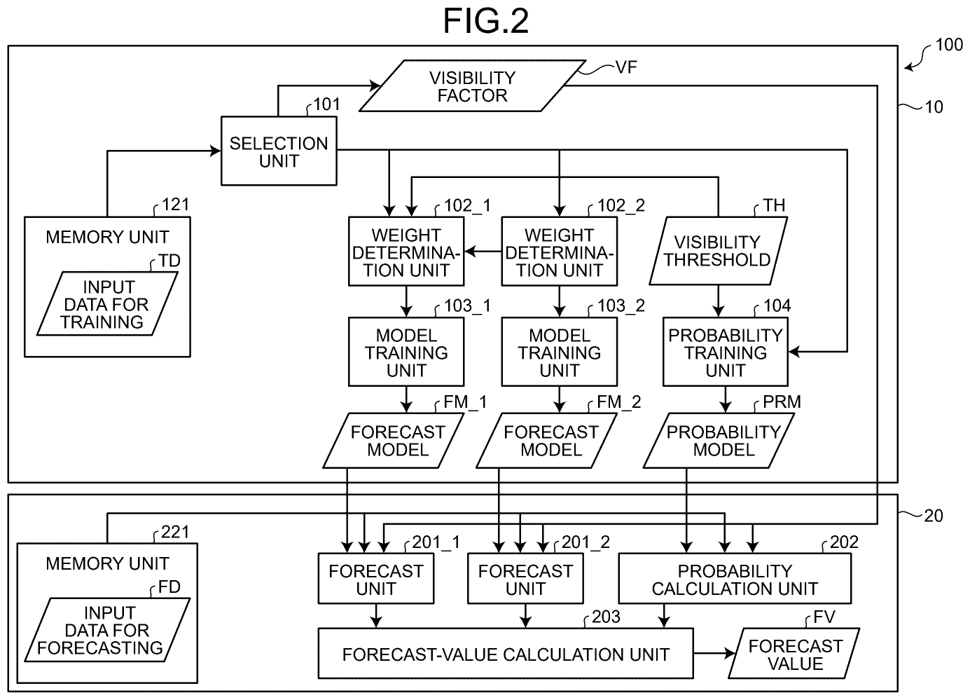

FIG. 2 is a block diagram illustrating a configuration example of an information processing apparatus 100 of the first embodiment. As illustrated in FIG. 2, the information processing apparatus 100 includes a training controller 10 and a forecast controller 20.

The training controller 10 controls the training processing of the forecast models. The forecasting controller 20 controls the forecasting processing using the trained forecast models.

At least one of the above-mentioned controllers (the training controller 10 and the forecasting controller 20) may be implemented by one or more processing units. The above-mentioned controllers are implemented by, for example, one or more processors. The above-mentioned units may be implemented by causing a processor such as a central processing unit (CPU) or a graphics processing unit (GPU) to execute a computer program, namely, implemented by software. The above-mentioned controllers may be implemented by a processor such as a dedicated integrated circuit (IC), namely, implemented by hardware. The above-mentioned controllers may be implemented using a combination of software and hardware. In the case of using multiple processors, each of the processors may implement one of the controllers or may implement two or more of the controllers.

The information processing apparatus 100 may be physically composed of a single device or may be physically composed of a plurality of devices. In one example, the information processing apparatus 100 may be built on a cloud environment. The controllers of the information processing apparatus 100 may be distributed among devices. In one example, the information processing apparatus 100 (an information processing system) may include a device including the training controller 10 (for example, a training device) and a device including the forecasting controller 20 (for example, a forecast device).

At least one constituent of the information processing apparatus 100 may be chip-based. At least one constituent of the information processing apparatus 100 may be incorporated in a system-on-chip (SoC), such as an edge device. In this case, a memory unit configured to store data to be used for training (a memory unit 121 to be described later) and a memory unit configured to store data to be used for forecasting (a memory unit 221 to be described later) may be provided outside the SoC and accessible via an interface device.

The training controller 10 includes the memory unit 121, a selection unit 101, a weight determination unit 102_1, a weight determination unit 102_2, a model training unit 103_1, a model training unit 103_2, and a probability training unit 104.

The memory unit 121 stores various types of information to be used by the training controller 10. The memory unit 121 stores, for example, input data for training TD and a visibility threshold TH that are used for training processing, and output data outputted through the training processing. The output data includes, for example, a visibility factor VF, a forecast model FM_1, a forecast model FM_2, and a probability model PRM. In FIG. 2, for convenience of description, only the input data for training TD are illustrated inside the memory unit 121, but the memory unit 121 may store other types of data (for example, the output data) as well.

The input data for training TD are data to be inputted for training the forecast models (the forecast model FM_1 and the forecast model FM_2). In one example, the input data for training TD include a plurality of types of weather data for a plurality of dates and times (time stamps). The weather data may be any type of data, and may include an atmospheric pressure, a dew-point temperature, a wind velocity, a relative humidity, an amount of precipitation, an atmospheric temperature, and an air pollution index (for example, PM2.5, PM10, NOx, CO, or NMHC).

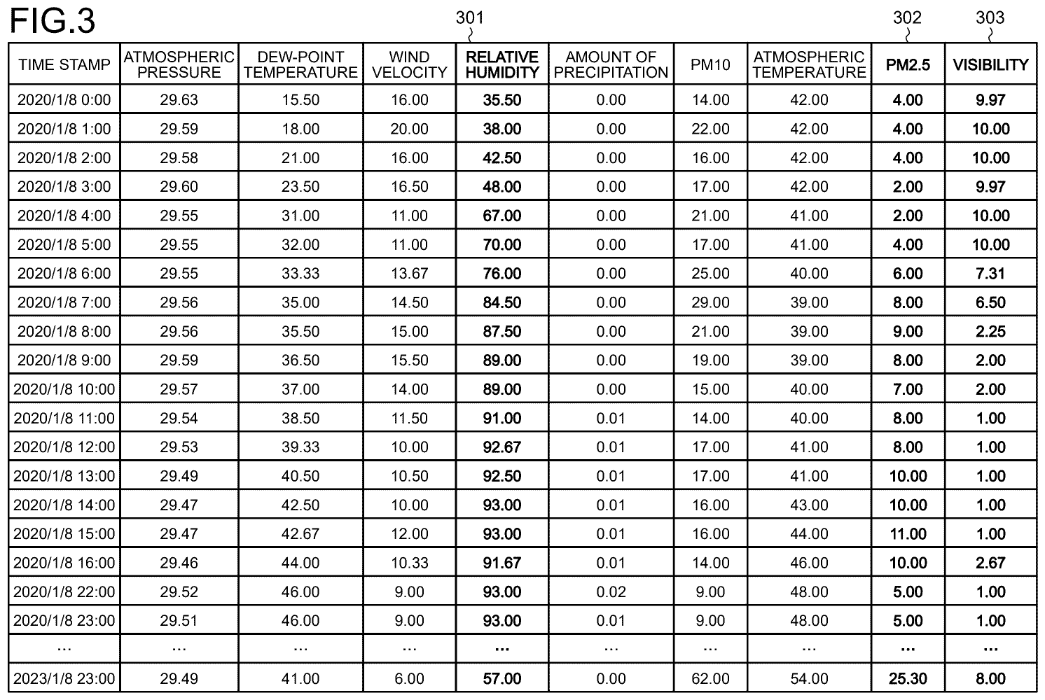

FIG. 3 is a diagram illustrating an example of the input data for training TD. In the example in FIG. 3, the input data for training TD include a time stamp, an atmospheric pressure, a dew-point temperature, a wind velocity, a relative humidity, an amount of precipitation, PM10, an atmospheric temperature, PM2.5, and visibility.

A plurality of types of weather data (factors) included in the input data for training TD corresponds to a plurality of candidates for the visibility factor VF serving as an explanatory variable. In other words, at least one explanatory variable defined by the visibility factor VF and a visibility value (visibility data) serving as an objective variable are selected from the input data for training TD, whereby training data sets including the selected explanatory variable and the objective variable are generated. In the following, data selected as the visibility factor VF are sometimes referred to as visibility factor data for training.

The at least one explanatory variable may be any data, and may include some of or all the following data.
Visibility data observed in the past
Weather data, other than visibility data, observed in the past
Predicted value of weather data

The visibility value serving as the objective variable corresponds to a visibility value to be used as correct data during training. In one example, when visibility values are forecasted in a forecast target period that is after the lapse of a certain period of time (for example, from one to six hours later at one-hour intervals), based on weather data observed in the past, visibility values observed after the lapse of the certain period of time following the observation of the weather data corresponding to the explanatory variables are used as the correct data.

In the example in FIG. 3, data 301 indicating relative humidity, data 302 indicating PM2.5, and data 303 indicating visibility are selected as visibility factors (explanatory variables). Thus, in the example in FIG. 3, the visibility factor data for training include relative humidity, PM2.5, and visibility.

A visibility threshold TH is a threshold for dividing the training data set including the visibility factor data for training into plural groups. Since the range of visibility changes with the purpose of use, a value of the visibility threshold TH may be changed with the purpose of use.

The memory unit 121 can be composed of any commonly used storage medium, such as a flash memory, a memory card, a random access memory (RAM), a hard disk drive (HDD), or an optical disk. Some of or all the pieces of data to be stored in the memory unit 121 (the input data for training TD, the visibility threshold TH, the visibility factor VF, the forecast model FM_1, the forecast model FM_2, and the probability model PRM) may be stored in physically different storage media, or may be stored in different storage areas of physically the same storage medium.

Return to the description of FIG. 2. The selection unit 101 selects the visibility factor VF from the input data for training TD. In one example, from among candidates (weather data) for the explanatory variable included in the input data for training TD, the selection unit 101 selects, as a visibility factor VF, at least one candidate C1 (a first candidate) that affects the forecasting of a visibility value. The selection unit 101 stores the selected visibility factor VF in the memory unit 121. Moreover, the selection unit 101 generates training data sets including the at least one visibility factor VF (the candidate C1) selected as an explanatory variable.

The following methods can be applied as methods for selecting the visibility factor VF.
(M1) Selecting the visibility factor VF in accordance with the knowledge of experts and the likes
(M2) Selecting, as the visibility factor VF, a candidate having a stronger cross-correlation with the visibility value than other candidates
(M3) Selecting, as the visibility factor VF, a candidate having a higher degree of accuracy in forecasting by a model M_VF configured to forecast a visibility value by using a candidate as the explanatory variable, than other candidates

A description of (M2) is given below. It is assumed that the input data for training TD include an atmospheric pressure, a dew-point temperature, a wind velocity, a relative humidity, an amount of precipitation, PM10, an atmospheric temperature, and PM2.5 as candidates for the factors. The selection unit 101 calculates a correlation coefficient between visibility and each of the candidates, and selects, as the visibility factor VF, the candidate for which a correlation coefficient indicating high correlation has been calculated. In the case of a correlation coefficient whose higher value indicates a higher correlation, the selection unit 101 selects, as the visibility factor VF, a candidate having a correlation coefficient value larger than a threshold value, a certain number of candidates in descending order of correlation coefficient value, or a certain proportion of top-ranked candidates in descending order of correlation coefficient value.

In one example, when the threshold value is 0.5 and the correlation coefficient between each of the candidates and visibility is as follows, the selection unit 101 selects, as the visibility factors VF, the relative humidity and PM2.5, whose correlation coefficient values are larger than the threshold value of 0.5.
Atmospheric pressure: 0.40
Dew-point temperature: 0.45
Wind velocity: 0.20
Relative humidity: 0.82
Amount of precipitation: 0.34
PM10: 0.28
Atmospheric temperature: 0.48
PM2.5:0.90

A description of (M3) is given below. The selection unit 101 divides the input data for training TD into teaching data and validation data. The selection unit 101 generates various combinations of candidates included in the teaching data and trains a model M_VF by using the training data set including the combinations as explanatory variables. The model M_VF may be any model configured to forecast visibility, and may be, for example, a model having the same structure as that of the forecast model FM_1 or the forecast model FM_2 and being built by using the same training method as for that of the forecast model FM_1 or the forecast model FM_2.

The selection unit 101 evaluates the trained model M_VF by using the validation data and calculates an evaluation score. The evaluation score may be any index. Examples of the index that can be used include a root mean squared error (RMSE), a mean absolute error (MAE), and a determination coefficient (R2).

The selection unit 101 selects, as the visibility factors VF, candidates included in a combination exhibiting the best evaluation score. Similar to the above, when the input data for training TD include eight candidates, namely, an atmospheric pressure, a dew-point temperature, a wind velocity, a relative humidity, an amount of precipitation, PM10, an atmospheric temperature, and PM2.5, there are 255 (=28-1) combinations of the candidates. Examples of the combinations are listed below.

{atmospheric pressure}, {dew-point temperature}, {wind velocity}, {relative humidity}, {amount of precipitation}, {PM10}, {atmospheric temperature}, {PM2.5}, . . . , {relative humidity, PM2.5}, {dew-point temperature, PM10}, . . . , {atmospheric pressure, dew-point temperature, wind velocity, relative humidity}, {amount of precipitation, PM10, atmospheric temperature, PM2.5}, . . . , {atmospheric pressure, dew-point temperature, wind velocity, relative humidity, amount of precipitation, PM10, atmospheric temperature, PM2.5}

In the above examples, visibility is excluded from candidate factors to be included in the combinations. In this case, the selection unit 101 may further include visibility as the visibility factor VF. The selection unit 101 may perform the above-mentioned processing while visibility is included as a candidate factor to be included in the combinations.

When generating combinations of candidates, the selection unit 101 may use sequential forward selection (SFS), sequential backward selection (SBS), and genetic algorithms.

Return to the description of FIG. 2. The weight determination unit 102_1 and the weight determination unit 102_2 determine weights in accordance with visibility values included in a plurality of training data sets by using mutually different determination methods. In the present embodiment, the number m of the determination methods is assumed to be 2.

The determination methods are methods using plural training data sets to determine weights in accordance with visibility values included in the training data sets. A weight is determined for each of the training data sets (each sample), and each of the determined weights is assigned to a corresponding one of the training data sets. The two determination methods include a determination method DT_A (a first determination method) to be used by the weight determination unit 102_1 and a determination method DT_B to be used by the weight determination unit 102_2.

The determination method DT_A is a method of determining to assign a larger weight W_{A} to the training data set including a visibility value VA (a first visibility value) than other visibility values, the visibility value VA occurring with lower frequency than the other visibility values. The visibility value VA is, for example, a low visibility value. The determination method DT_B may be any method that differs from the determination method DT_A, and is, for example, a method (a second determination method) of determining a weight W_{B} by using the kernel density estimation.

The weight determination unit 102_1 determines a weight to be assigned to the training data set for training the forecast model FM_1 in accordance with the determination method DT_A. First, the weight determination unit 102_1 divides the training data set into m groups by using the visibility threshold TH.

When m=2 as in the present embodiment, the weight determination unit 102_1 classifies the training data set including visibility values (low visibility values) equal to or smaller than the visibility threshold TH, as a group corresponding to the low visibility values (hereinafter referred to as a low visibility group). The visibility values equal to or smaller than the visibility threshold TH are examples of the visibility value VA that occurs with lower frequency than other visibility values. Moreover, the weight determination unit 102_1 classifies the training data set including visibility values (high visibility values) larger than the visibility threshold TH, as a group corresponding to the high visibility values (hereinafter referred to as a high visibility group).

The weight determination unit 102_1 determines a predetermined value for each of the groups as a value of the weight W_{A}. A value B1 for a group corresponding to a visibility value to be focused on is defined to be larger than a value B2 for another group. In one example, when low visibility is focused on, the weight determination unit 102_1 determines to assign β₁=9999 as a value of the weight W_{A} to a group corresponding to low visibility values. Moreover, the weight determination unit 102_1 determines to assign β₂=1 as a value of the weight W_{A} to another group (the group corresponding to the high visibility values).

In accordance with the determination method DT_B, the weight determination unit 102_2 determines a weight W_{B} to be assigned to the training data set for training the forecast model FM_2. Hereinafter, an example of the determination method DT_B, which uses the kernel density estimation to determine the weight W_{B}, will be described.

As the method that uses the kernel density estimation, a method of determining a weight for a rare value, based on the kernel density estimation can be used (see, for example, Steininger, M., Kobs, K., Davidson, P. et al., “Density-based weighting for imbalanced regression”, Mach Learn 110, 2187-2211 (2021)). The weight determination unit 102_2 determines the weight W_{B}(y) for visibility y by using the following formula (1), for example.

$${W}_{B} ( y ) = max ( 1 - α {p}^{′} ( y ) , ϵ ) \qquad ( 1 )$$

Note that determining the weight for the visibility y is equivalent to determining a weight for a training data set including the visibility y. The visibility y means a value of visibility included in one of training data sets. Hereinafter, Y represents a set of all visibility y included in the training data sets.

α and ε in the formula (1) are predetermined parameters. In one example, 0.7 is used as a value of a and 0.4 is used as a value of ε. p′(y) is expressed by the following formula (2). p(y) in the formula (2) is expressed by the following formula (3).

$${p}^{′} ( y ) = \frac{p ( y ) - min ( p ( Y ) )}{max ( p ( Y ) ) - min ( p ( Y ) )} \qquad ( 2 )$$

$$p ( y ) = \frac{1}{Nh} {\sum }_{i = 1}^{N} K ( \frac{y - {y}_{i}}{h} ) \qquad ( 3 )$$

N is the number of samples of the training data sets, h is a bandwidth (for example, 10), and K is a kernel function. The kernel function is, for example, a standard Gaussian function, and expressed by the following formula (4). Note that x is expressed as x=(y−yᵢ)/h.

$$K ( x ) = \frac{1}{\sqrt{2 π}} {e}^{- \frac{{x}^{2}}{2}} \qquad ( 4 )$$

The weight determination unit 102_1 may determine the weight W_{A} in consideration of the weight W_{B} determined by the weight determination unit 102_2. In one example, the weight determination unit 102_1 may determine the weight W_{A} by using the following formula (5).

$${W}_{A} ( y ) = f ( y , {W}_{1} ( y ) ) = \{ \begin{matrix}{β}_{1} & {W}_{B} ( y ) > THRESHOLD \\ {β}_{2} & {W}_{B} ( y ) \leq THRESHOLD\end{matrix} \qquad ( 5 )$$

The threshold is equivalent to the visibility threshold TH for classifying values of the weight W_{B}(y). When forecasting of low visibility with high accuracy is focused on, the threshold is, for example, the lowest value of the weight W_{B}(y) for the low visibility group. In one example, the threshold may be set to 0.5, β₁ may be set to 9999, and β₂ may be set to 1.

The model training unit 103_1 and the model training unit 103_2 correspond to model training units configured to train m forecast models by using plural training data sets assigned with weights determined by m (two in the present embodiment) determination methods, respectively. The model training unit 103_1 and the model training unit 103_2 correspond to the weight determination unit 102_1 (the determination method DT_A) and the weight determination unit 102_2 (the determination method DT_B), respectively.

The model training unit 103_1 trains the forecast model FM_1 by using the training data set assigned with the weight W_{A} determined by the weight determination unit 102_1 in accordance with the determination method DT_A. The model training unit 103_2 trains the forecast model FM_2 by using the training data set assigned with the weight W_{B} determined by the weight determination unit 102_2 in accordance with the determination method DT_B.

Any method may be applied for training the models (the forecast model FM_1 and the forecast model FM_2) by using the weighted training data set. For example, a training method using the following techniques can be applied.
Gradient boosting (for example, Light Gradient Boosting Machine: LGBM)
Deep Learning
Long Short Term Memory (LSTM)
Transformer
Ridge regression
Linear regression
DLinear

The model training unit 103_1 and the model training unit 103_2 may use the same training method or may use respective different training methods.

The probability training unit 104 trains a probability model PRM by using plural training data sets. The probability model PRM is a model capable of forecasting the probability that a visibility value is a visibility value VA (a visibility value that occurs with low frequency), by inputting at least one explanatory variable. The probability model PRM can be interpreted as a model that forecasts the probabilities of a visibility value belonging to two groups (the low visibility group and the high visibility value group), respectively.

In the present embodiment model, the probability model PRM is a model that outputs the probability that a visibility value is the visibility value VA and the probability that the visibility value is not the visibility value VA. In other words, the probability model PRM is equivalent to a model that forecasts the probability of a visibility value belonging to the low visibility group and the probability of the visibility value belonging to the high visibility group. The probability model PRM can be interpreted as a classifier that performs classification into the low visibility group and the high visibility group.

Any method can be applied for training the probability model PRM. For example, a training method using the following techniques can be applied.
Logistic regression
k-nearest neighbor
Support vector machine
Decision tree
Deep Learning
Self-encoder (autoencoder)

The probability training unit 104 may train the probability model PRM by using weighted training data set. In one example, the probability training unit 104 may assign a larger value of weight to the training data set (low visibility group) including the visibility value VA that occurs with lower frequency, as in the determination method DT_A. A value of weight assigned to each of the groups may be the same as or different from a value used by the weight determination unit 102_1.

The forecast model FM_1 trained by the model training unit 103_1, the forecast model FM_2 trained by the model training unit 103_2, and the probability model PRM trained by the probability training unit 104 are stored in the memory unit 121, for example.

Next, a specific example of the forecasting controller 20 will be described. As illustrated in FIG. 2, the forecasting controller 20 includes the memory unit 221, a forecast unit 201_1, a forecast unit 201_2, a probability calculation unit 202, and an forecast-value calculation unit 203.

The memory unit 221 stores various types of information to be used by the forecasting controller 20. The memory unit 221 stores, for example, input data for forecasting FD, which is to be used in forecasting processing, and a forecast value FV, which is the result of calculation by the forecast-value calculation unit 203. In FIG. 2, for convenience of description, only the input data for forecasting FD are stored inside the memory unit 221, but the memory unit 221 may store other types of data (for example, the forecast value FV) as well.

The input data for forecasting FD are data inputted for the forecasting processing using the forecast models (the forecast model FM_1 and the forecast model FM_2). The input data for forecasting FD can be in the same data format as for the input data for training TD. In other words, the input data for forecasting FD include a plurality of types of weather data for a plurality of dates and times (time stamps).

The memory unit 221 can be composed of any commonly used storage medium, such as a flash memory, a memory card, a random access memory (RAM), a hard disk drive (HDD), or an optical disk.

The forecasting unit 201_1 and the forecasting unit 201_2 are forecasting units configured to forecast m (two) visibility values for at least one explanatory variable for forecasting by using m (two in the present embodiment) forecast models (the forecast model FM_1 and the forecast model FM_2), respectively.

The forecasting unit 201_1 extracts data of the visibility factor VF from the input data for forecasting FD, first. Hereinafter, the extracted data will be referred to as visibility factor data for forecasting. The visibility factor data for forecasting corresponds to input data including an explanatory variable to be inputted to the forecast model FM_1. The forecasting unit 201_1 inputs the visibility factor data for forecasting to the forecast model FM_1 and calculates a forecast value FV_1 of visibility.

The forecasting unit 201_2 inputs the visibility factor data for forecasting to the forecast model FM_2 and calculates a forecast value FV_2 of visibility. The forecasting unit 201_2 may use the visibility factor data for forecasting extracted by the forecasting unit 201_1, or may use the visibility factor data for forecasting extracted from the input data for forecasting FD as the data of the visibility factor VF.

The probability calculation unit 202 inputs the visibility factor data for forecasting to the probability model PRM and calculates probabilities. As described above, the calculated probabilities include the probability of the low visibility group and the probability of the high visibility group. The probabilities may be interpreted to include the probability of the forecast value FV_1 (hereinafter referred to as “probability PR_1”) and the probability of the forecast value FV_2 (hereinafter referred to as “probability PR_2”).

The forecast-value calculation unit 203 uses m (two) forecast values of visibility (the forecast value FV_1 and the forecast value FV_2) to calculate a final forecast value FV of visibility. The forecast value FV is stored, for example, in the memory unit 221. The forecast-value calculation unit 203 calculates the forecast value FV by using the forecast value FV_1, the forecast value FV_2, the probability PR_1, and the probability PR_2.

As a method of calculating an forecast value FV by using probabilities, the following methods can be applied.
Of the forecast value FV_1 and the forecast value FV_2, the one with higher corresponding probability is calculated as the forecast value FV.
The weighted average of the forecast value FV_1 and the forecast value FV_2, in which the probability PR_1 and the probability PR_2 are used as weights, respectively, is calculated as the forecast value FV.

The forecasting controller 20 may include a function of outputting the forecast value FV. In one example, the forecasting controller 20 may display the forecast value FV on a display device (such as a liquid-crystal display). The forecasting controller 20 may send the forecast value FV to an external device connected via a network.

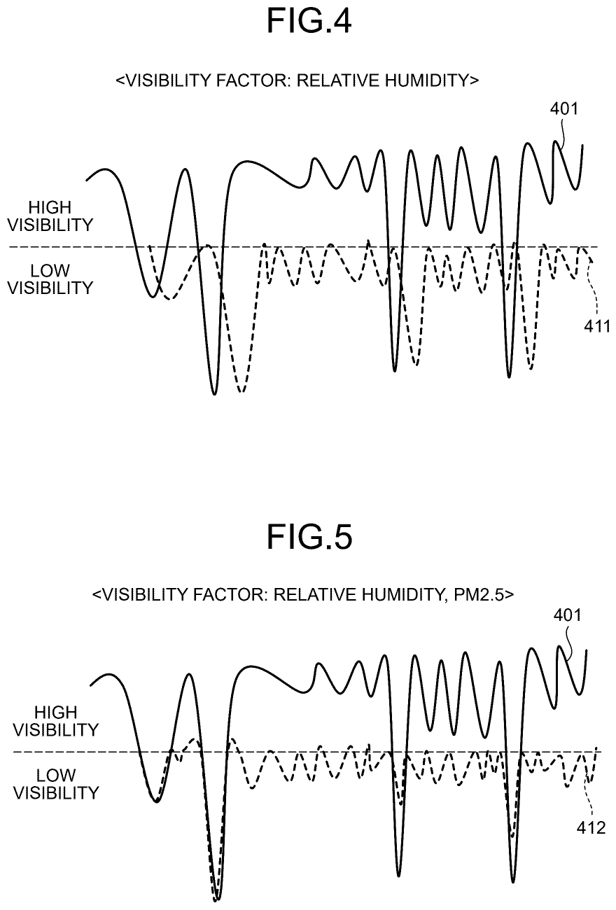

Next, an example of processing by the information processing apparatus 100 will be described. FIG. 4 and FIG. 5 are diagrams illustrating specific examples of selection processing by the selection unit 101.

FIG. 4 is a diagram illustrating an example in which an inappropriate visibility factor is selected. In FIG. 4, the example in which relative humidity is selected as the inappropriate visibility factor is illustrated. Data 401 indicate an example of visibility included in the teaching data. Data 411 indicate an example of the result of forecasting by a model M_VF trained using the teaching data including only relative humidity as a visibility factor. When an inappropriate visibility factor is used, a peak shift in the result of forecasting may occur, as indicated by the data 411 in FIG. 4. When the peak shift occurs, a value of evaluation score such as RMSE deteriorates.

FIG. 5 is a diagram illustrating an example in which appropriate visibility factors are selected. In FIG. 5, an example in which a combination of relative humidity and PM2.5 is selected as appropriate visibility factors is illustrated. Data 412 indicate an example of the result of forecasting by a model M_VF trained using the teaching data including a combination of relative humidity and PM2.5 as visibility factors. When an appropriate visibility factor is used, no peak shift in the result of forecasting occurs as illustrated in the data 412 in FIG. 5. As a result, a value evaluated higher is calculated as an evaluation score such as RMSE. When the evaluation score is the best value, the selection unit 101 selects relative humidity and PM2.5 as visibility factors VF.

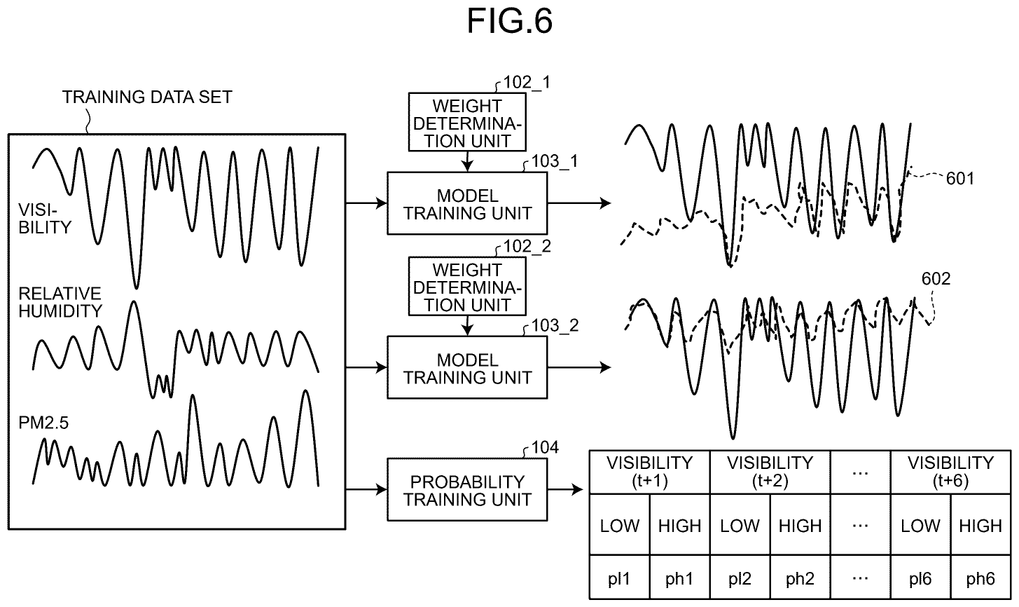

Next, a specific example of training processing for models (the forecast model FM_1, the forecast model FM_2, and the probability model PRM) will be described. FIG. 6 is a diagram illustrating a specific example of training processing for models. In the example in FIG. 6, visibility, relative humidity and PM2.5 are used as visibility factors. In FIG. 6, an example in which hourly times from one to six hours later are used as forecast target times is illustrated.

The weight determination unit 102_1 focuses on low visibility and determines to assign a larger value of weight to a group corresponding to low visibility values. The model training unit 103_1 uses the weighted training data set to train the forecast model FM_1. Thus, the forecast model FM_1 becomes a model capable of forecasting low visibility values with higher accuracy, as indicated by a forecast result 601.

The weight determination unit 102_2 determines a weight by using the kernel density estimation, for example. The model training unit 103_2 uses the weighted training data set to train the forecast model FM_2. Thus, the forecast model FM_2 becomes a model capable of forecasting high visibility values with higher accuracy when compared to the forecast model FM_1, as indicated by a forecast result 602.

The probability training unit 104 trains a probability model that forecasts probabilities of low visibility (pl1 to pl6) and probabilities of high visibility (ph1 to ph6) for the next six hours.

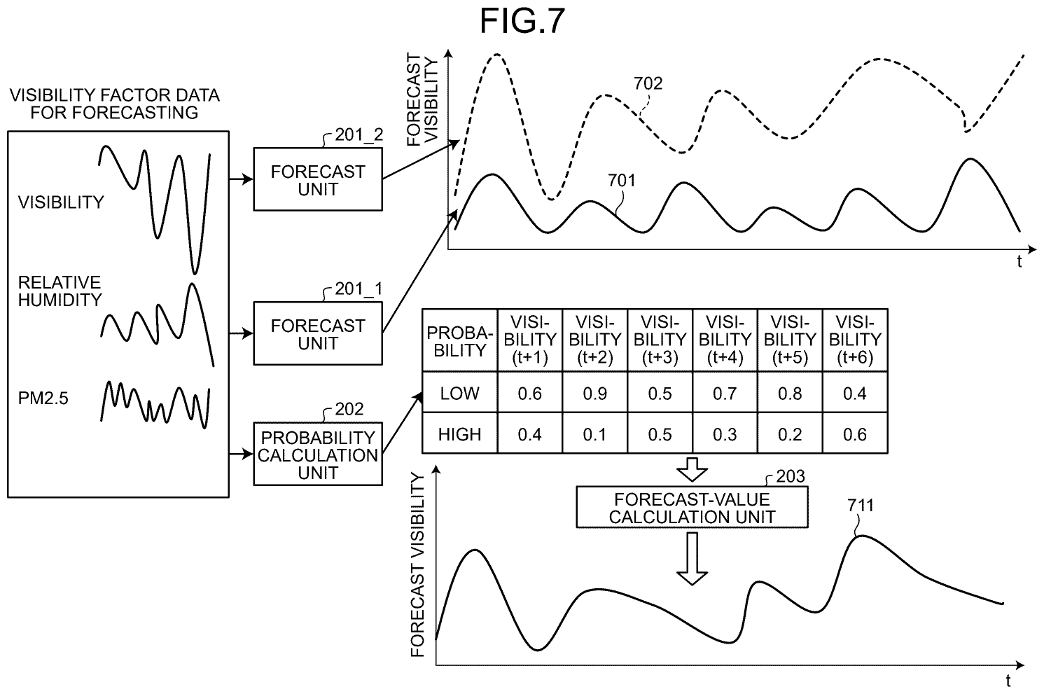

Next, a specific example of forecasting processing using a trained model will be described. FIG. 7 is a diagram illustrating the specific example of the forecasting processing using the model. In the example in FIG. 7, visibility, relative humidity and PM2.5 are used as visibility factors. In FIG. 6, the example in which hourly times from one to six hours later are used as the forecast target times is illustrated.

The forecasting unit 201_2 extracts visibility factor data for forecasting from the input data for forecasting FD, and inputs the extracted visibility factor data for forecasting into the forecast model FM_2 and calculates forecast values FV_2 of visibility for the next six hours. Data 702 correspond to the forecast values FV_2 for the next six hours.

The forecasting unit 201_1 inputs the visibility factor data for forecasting into the forecast model FM_1 and calculates forecast values FV_1 of visibility for the next six hours. Data 701 correspond to the forecast values FV_1 for the next six hours.

The probability calculation unit 202 inputs the visibility factor data for forecasting into the probability model PRM to forecast the probability of low visibility and the probability of high visibility for the next six hours.

The forecast-value calculation unit 203 calculates the weighted average of the forecast values FV_1 and the forecast values FV_2 as an forecast value FV by using the probability of low visibility and the probability of high visibility as weights to be assigned to the forecast values FV_1 and the forecast values FV_2, respectively. Data 711 correspond to the forecast value FV.

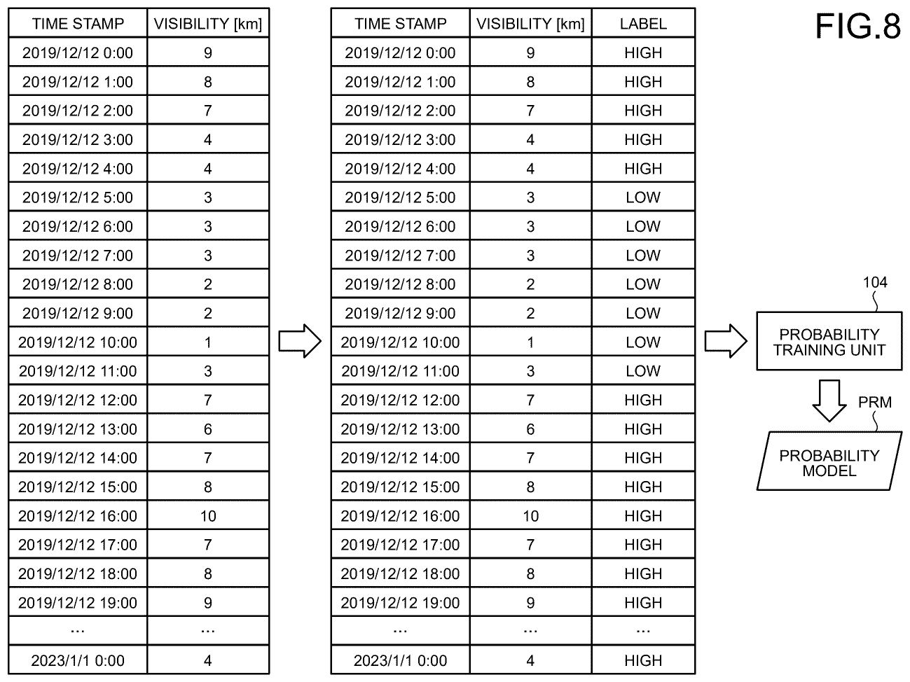

Next, a specific example of training processing for the probability model PRM will be described. FIG. 8 is a diagram illustrating the specific example of the training processing for the probability model PRM. In the example in FIG. 8, visibility factor data for training are divided into a low visibility group and a high visibility group, assuming that low visibility is a distance of 3 km or less.

In one example, the probability training unit 104 assigns a label “low” indicating low visibility to visibility factor data for training when visibility included in the visibility factor data for training is 3 km or less, meanwhile the probability training unit 104 assigns a label “high” indicating high visibility to the visibility factor data for training when visibility is greater than 3 km. Using the labeled visibility factor data for training, the probability training unit 104 trains the probability model PRM that forecasts the probability of low visibility and the probability of high visibility.

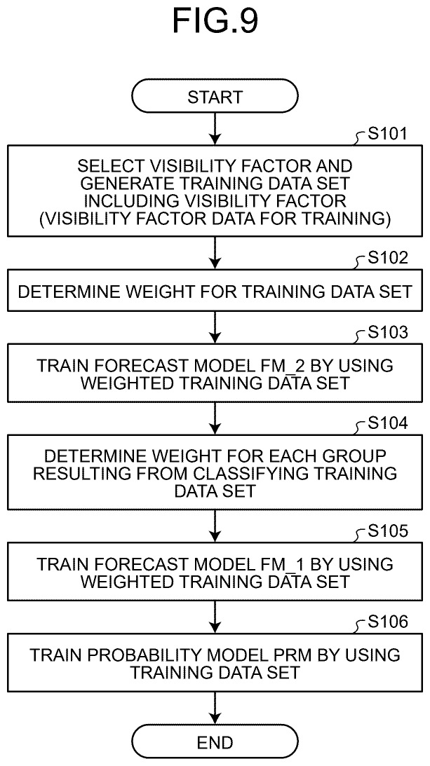

Next, the procedure of training processing by the information processing apparatus 100 of the first embodiment will be described. FIG. 9 is a flowchart illustrating an example of the training processing in the first embodiment.

The selection unit 101 reads the input data for training TD from the memory unit 121, selects a visibility factor VF from the input data for training TD, and generates plural training data sets including: the visibility factor data for training including the selected visibility factor VF; and the visibility data corresponding to an objective variable (step S101).

The weight determination unit 102_2 determines a weight to be assigned to each of the training data sets (step S102). The model training unit 103_2 trains and outputs the forecast model FM_2 by using the weighted training data sets (step S103).

The weight determination unit 102_1 divides the training data sets into two visibility groups by using the visibility threshold TH in consideration of the weights determined by the weight determination unit 102_2, and determines a weight to be assigned to each of the training data sets (step S104). The model training unit 103_1 trains and outputs the forecast model FM_1 by using the weighted training data sets (step S105).

The probability training unit 104 divides the training data sets into two visibility groups and trains and outputs the probability model PRM that forecasts the probability of each of the groups (step S106).

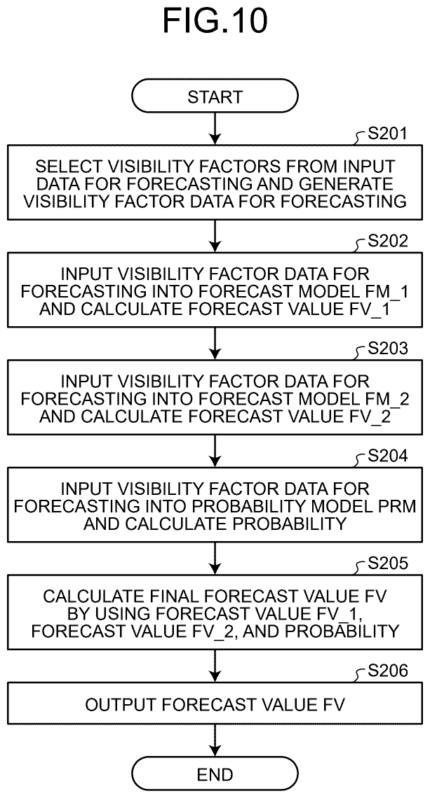

Next, the procedure of forecasting processing by the information processing apparatus 100 in the first embodiment will be described. FIG. 10 is a flowchart illustrating an example of the forecasting processing in the first embodiment.

The forecasting unit 201_1 reads the input data for forecasting FD from the memory unit 221, selects a visibility factor VF from the input data for forecasting FD, and generates visibility factor data for forecasting including the selected visibility factor VF (step S201). The visibility factor data for forecasting are outputted to the forecasting unit 201_2 and the probability calculation unit 202.

The forecasting unit 201_1 inputs the visibility factor data for forecasting into the forecast model FM_1 and calculates an forecast value FV_1 (step S202). The forecasting unit 201_2 inputs the visibility factor data for forecasting into the forecast model FM_2 and calculates an forecast value FV_2 (step S203). The probability calculation unit 202 inputs the visibility factor data for forecasting into the probability model PRM and calculates a probability PR_1 pf the forecast value FV_1 and a probability PR_2 of the forecast value FV_2 (step S204).

The forecast-value calculation unit 203 calculates a final forecast value FV by using the forecast value FV_1, the forecast value FV_2, the probability PR_1, and the probability PR_2 (step S205). The forecast-value calculation unit 203 outputs the calculated forecast value FV (step S206).

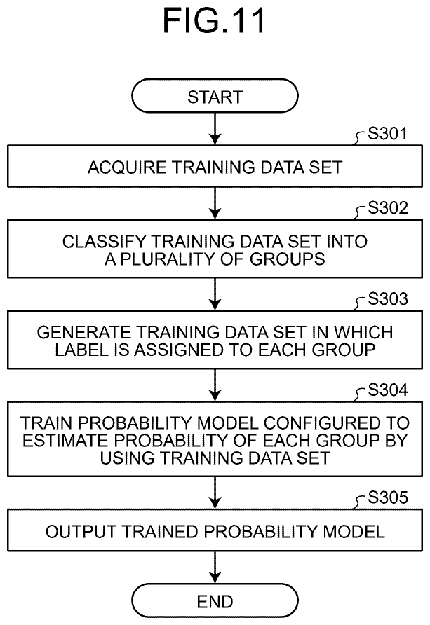

Next, the procedure of probability training processing by the information processing apparatus 100 in the first embodiment will be described. The probability training processing is processing of training the probability model PRM and corresponds to the processing at step S106 in FIG. 9. FIG. 11 is a flowchart illustrating an example of the probability training processing in the first embodiment.

The probability training unit 104 acquires the training data sets generated by the selection unit 101 (step S301). The probability training unit 104 classifies the training data sets into plural groups (a low visibility group and a high visibility group) by using the visibility threshold TH (step S302). The probability training unit 104 generates training data sets in which each of the groups is labeled (step S303).

Using the labeled training data sets, the probability training unit 104 trains the probability model PRM that forecasts the probability of each of the groups (step S304). The probability training unit 104 outputs the trained probability model PRM (step S305).

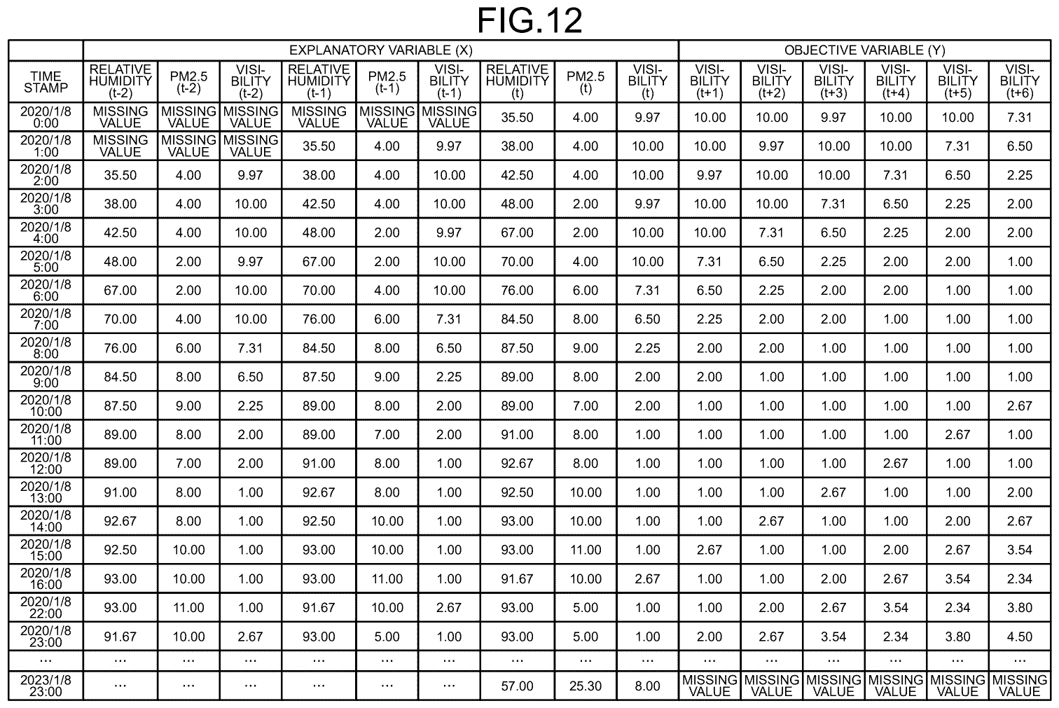

Next, an example of data to be used in the training processing and the forecasting processing will be described. FIG. 12 is a diagram illustrating an example of a training data set to be used in the training processing for models (the forecast model FM_1, the forecast model FM_2, and the probability model PRM).

In the example in FIG. 12, visibility factors are relative humidity, PM2.5, and visibility. Therefore, the visibility factor data for training include relative humidity (t), PM2.5 (t), and visibility (t), which indicate relative humidity, PM2.5, and visibility, respectively, at the time (current time) t of each time stamp. Relative humidity (t−1), PM2.5 (t−1), and visibility (t−1) are respectively relative humidity, PM2.5, and visibility one hour before the current time t of each time stamp. Relative humidity (t−2), PM2.5 (t−2), and visibility (t−2) are respectively relative humidity, PM2.5, and visibility two hours before the current time t of each time stamp.

Objective variables include visibility (t+1), visibility (t+2), visibility (t+3), visibility (t+4), visibility (t+5), and visibility (t+6), which are respectively visibility one hour later from the current time t of each time stamp, visibility two hours later therefrom, visibility three hours later therefrom, visibility four hours later therefrom, visibility five hours later therefrom, and visibility six hours later therefrom.

In the training processing, relative humidity (t−2), PM2.5 (t−2), visibility (t−2), relative humidity (t−1), PM2.5 (t−1), visibility (t−1), relative humidity (t), PM2.5 (t), and visibility (t) are explanatory variables, meanwhile visibility (t+1), visibility (t+2), visibility (t+3), visibility (t+4), visibility (t+5), and visibility (t+6) are objective variables.

The model training unit 103_1 and the model training unit 103_2 trains the forecast models (the forecast model FM_1 and the forecast model FM_2) that indicate the relationship between the explanatory variables and the objective variables. The probability training unit 104 assigns labels to values of the visibility (t+1), the visibility (t+2), the visibility (t+3), the visibility (t+4), the visibility (t+5), and the visibility (t+6), respectively, at each time stamp by using the visibility threshold TH, and trains the probability model PRM by using the labeled data of the explanatory variables.

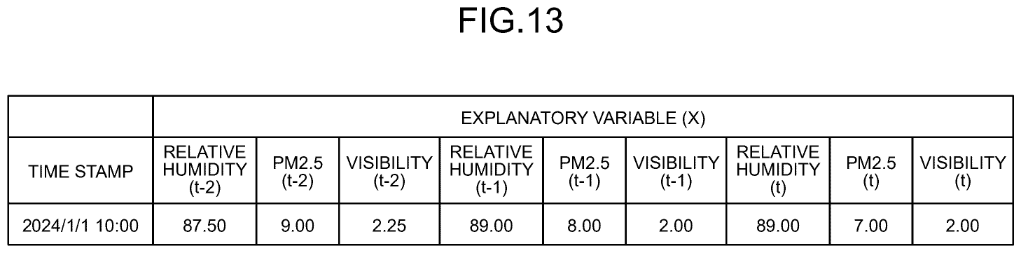

FIG. 13 is a diagram illustrating an example of data (visibility factor data for forecasting) to be used in the forecasting processing by the models (the forecast model FM_1, the forecast model FM_2, and the probability model PRM).

In the example in FIG. 13, visibility factors are relative humidity, PM2.5, and visibility. The visibility factor data for forecasting include: relative humidity (t), PM2.5 (t), and visibility (t) at the current time t for each time stamp; relative humidity (t−1), PM2.5 (t−1), and visibility (t−1) one hour before the current time t; and relative humidity (t−2), PM2.5 (t−2), and visibility (t−2) at 2 hours before the current time t.

The forecasting unit 201_2 and the forecasting unit 201_1 input the visibility factor data for forecasting as explanatory variables into the forecast model FM_1 and the forecast model FM_2, respectively, and calculate visibility one to six hours later from the current time, namely, visibility (t+1), visibility (t+2), visibility (t+3), visibility (t+4), visibility (t+5), and visibility (t+6).

The probability calculation unit 202 inputs the visibility factor data for forecasting as explanatory variables into the probability model PRM and calculates the probability of an forecast value FV_1 and the probability of an forecast value FV_2 of each visibility one to six hours later from the current time in the forecasting target period, namely, the visibility (t+1), the visibility (t+2), the visibility (t+3), the visibility (t+4), the visibility (t+5), and the visibility (t+6).

The case in which data occurring with low frequency are data including low visibility values has been described so far, but the data occurring with low frequency is not limited to the data including low visibility values, but can be data including any visibility values. Depending on a region and a season, data including high visibility values may become data occurring with high frequency. Even in such a case, the same procedure as above can be applied by using data occurring with low frequency as data including high visibility values and using data occurring with high frequency as data including low visibility values.

There is a possibility that, by using a method of determining a weight for a rare value, based on the kernel density estimation (see, for example, Steininger, M., Kobs, K., Davidson, P. et al., “Density-based weighting for imbalanced regression”, Mach Learn 110, 2187-2211 (2021)), a forecast model with higher forecasting accuracy can be built, compared to a method not using a weight. In the present embodiment, not only a method using the kernel density estimation (the determination method DT_B), but also a method of determining to assign a larger weight to a visibility value occurring with low frequency (the determination method DT_A) are used. Thus, visibility whose frequency of occurrence is possibly biased can be forecasted with higher accuracy.

### Second Embodiment

In the first embodiment, the case in which the number m of each of the weight determination units, the model training units (the forecast models), and the forecasting units is 2 has been described as an example. As described above, m is not limited to 2, but may be 3 or more. In the second embodiment, a configuration example in which the number of each of these constituents is generalized to be m will be described.

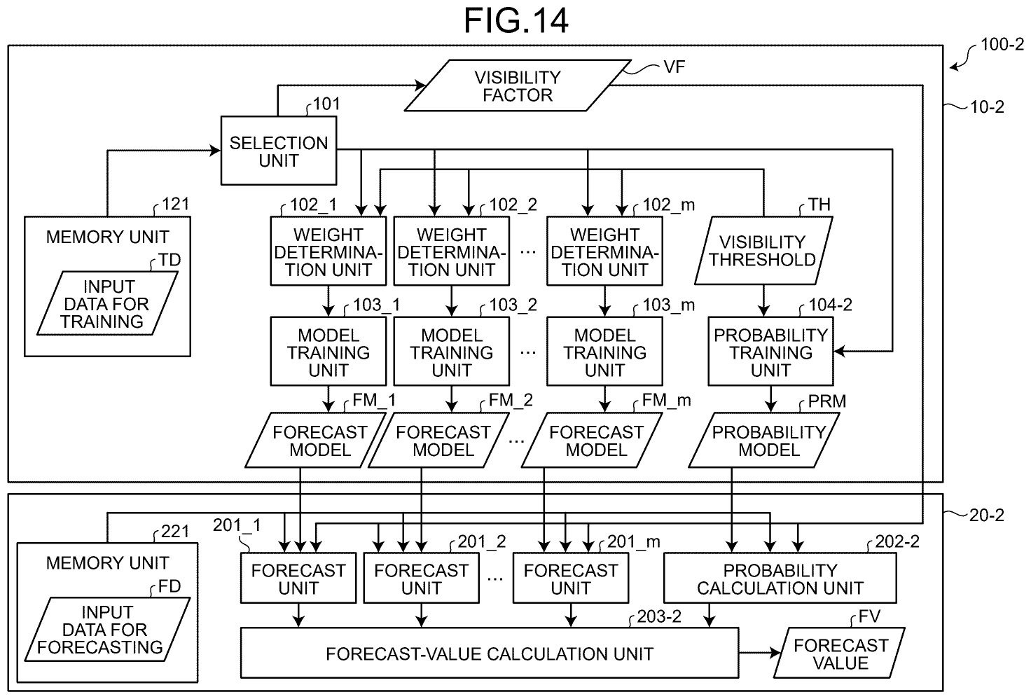

FIG. 14 is a diagram illustrating a configuration example of an information processing apparatus 100-2 of the second embodiment. As illustrated in FIG. 14, the information processing apparatus 100-2 includes a training controller 10-2 and a forecast controller 20-2.

The training controller 10-2 includes a memory unit 121, a selection unit 101, weight determination units 102_1 to 102_m, model training units 103_1 to 103_m, and a probability training unit 104-2. The forecasting controller 20-2 includes a memory unit 221, forecasting units 201_1 to 201_m, a probability calculation unit 202-2, and an forecast-value calculation unit 203-2.

The constituents that are the same as those illustrated in FIG. 1 being a block diagram of the information processing apparatus 100 of the first embodiment are denoted by the same reference numerals, and descriptions thereof are omitted here.

Each of the weight determination units 102_1 to 102_m determines a weight by a corresponding one of m mutually different determination methods. Hereinafter, an example of the m determination methods will be described.

The m determination methods may be methods of determining a weight for a corresponding one of m visibility groups that respectively correspond to m ranges of visibility. In this case, the visibility threshold TH may include (m−1) values and divide the ranges of visibility into m ranges.

The weight determination unit 102_j (j is an integer satisfying 1≤j≤m) uses the j^{th} determination method. The j^{th} determination method is a method of determining to assign a larger weight to the j^{th} group than to other groups among m groups divided using the visibility threshold TH.

A case in which visibility values are each between 0 and 10 inclusive, m=4, and the visibility threshold TH includes three values, namely, 2.5, 5.0, and 7.5 will be described as an example. In this case, the visibility values are divided into the following four groups.
Visibility group G1: a group including visibility values equal to 0.0 or larger and equal to 2.5 or smaller (equivalent to the low visibility group)
Visibility Group G2: a group including visibility values larger than 2.5 and equal to or smaller than 5.0
Visibility Group G3: a group including visibility values larger than 5.0 and equal to or smaller than 7.5
Visibility Group G4: a group including visibility values larger than 7.5 and equal to or smaller than 10.0

In this case, for example, the weight determination unit 102_1 focuses on the visibility group G1 and determines to assign a large weight to the visibility group G1 and assign small weights to the other three visibility groups. The determination method to be used by the weight determination unit 102_1 is similar to the above-described determination method DT_A, which determines to assign a larger weight W_{A} to the training data set including the visibility value VA than other visibility values, the visibility value VA occurring with lower frequency than the other visibility values.

The weight determination unit 102_2 focuses on the visibility group G2 and determines to assign a large weight to the visibility group G2 and assign small weights to the other three visibility groups. The weight determination unit 102_3 and the weight determination unit 102_4 focus on the visibility groups G3 and G4, respectively, and perform the same processing as that by the weight determination unit 102_2.

The m methods of determining weights are not limited to the above-described methods, but can be any other methods that are mutually different. In one example, the method (the second determination method) of determining weights by the kernel density estimation by using the training data set included in the above-mentioned groups may be applied to some of or all the groups (the visibility groups G2 to G4) other than the low visibility group (the visibility group G1).

Each of the model training units 103_1 to 103_m trains a corresponding one of the forecast models FM_1 to FM_m by using training data sets assigned with a weight determined by a corresponding one of the m determination methods. For example, the model training unit 103_j trains the forecast model FM_j by using training data sets assigned with a weight determined by the weight determination unit 102_j.

The probability training unit 104-2 trains the probability model PRM that forecasts the probability of each of the m groups. In the present embodiment, the probability model PRM can be interpreted as a classifier that classifies the training data sets (visibility values) into any of the m groups.

Each of the forecasting units 201_1 to 201_m forecasts a visibility value by using a corresponding one of the m forecast models (the forecast models FM_1 to FM_m). For example, the forecasting unit 201_j inputs the visibility factor data for forecasting into the forecast model Em_j and calculates the forecast value Ev_j of visibility.

The probability calculation unit 202-2 inputs the visibility factor data for forecasting into the probability model PRM and calculates the respective probabilities PR_j of the m forecast values FV_j.

The forecast-value calculation unit 203-2 calculates an forecast value FV by using the m forecast values FV_j and the respective probabilities PR_j of the m forecast values FV_j. For example, when m=4, the forecast-value calculation unit 203-2 calculates the forecast value FV as follows.

$$Forecast value FV = forecast value FV\_ 1 \times probability PR\_ 1 + forecast value FV\_ 2 \times probability PR\_ 2 + forecast value FV\_ 3 \times probability PR\_ 3 + forecast value FV\_ 4 \times probability PR\_ 4$$

Thus, even when m is 3 or more, the information processing apparatus in the second embodiment can implement the same function as in the first embodiment.

As described above, according to the first and second embodiments, visibility can be forecasted with higher accuracy.

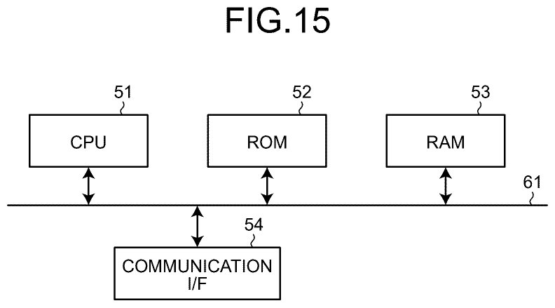

Next, a hardware configuration example of the information processing apparatus of the first or second embodiment will be described using FIG. 15. FIG. 15 is a diagram illustrating the hardware configuration example of the information processing apparatus of the first or second embodiment.

The information processing apparatus of the first or second embodiment includes a control device such as a central processing unit (CPU) 51, memory devices such as a read only memory (ROM) 52 and a random access memory (RAM) 53, a communication I/F 54 connected to a network and configured to carry out communications, and a bus 61 configured to connect constituents.

A computer program to be executed by the information processing apparatus of the first or second embodiment is incorporated into the ROM 52 and the like in advance and provided.

The computer program to be executed by the information processing apparatus of the first or second embodiment may be configured to be recorded in an installable or executable format file on a computer readable storage medium, such as a compact disc read only memory (CD-ROM), a flexible disk (FD), a compact disc recordable (CD-R), or a digital versatile disc (DVD), and provided as a computer program product.

Alternatively, the computer program to be executed by the information processing apparatus of the first or second embodiment may be configured to be stored in a computer connected to a network, such as the Internet, and provided by downloading via the network. Alternatively, the computer program to be executed by the information processing apparatus of the first or second embodiment may be configured to be provided or distributed via a network, such as the Internet.

The computer program to be executed by the information processing apparatus of the first or second embodiment can cause a computer to function as the above-described constituents of the information processing apparatus. The computer is capable of causing the CPU 51 to read the computer program from a computer-readable storage medium on its main memory and executing the computer program.

Next, configuration examples of the embodiments will be described.

### Configuration Example 1

An information processing apparatus comprising
one or more hardware processors configured to:
   determine weights by m mutually different determination methods (m is an integer more than or equal to 2), each determination method being a method using training data sets, each set including at least one explanatory variable and a visibility value as an objective variable, to determine the weights for the visibility values included in the training data sets, the m determination methods including a first determination method of determining to assign a larger weight to the training data set including a first visibility value than to other visibility values, the first visibility value occurring with lower frequency than the other visibility values; and
   train m forecast models configured to forecast the visibility values by inputting the at least one explanatory variable, the m forecast models being trained by using the training data sets assigned with the weights determined by the m determination methods.

### Configuration Example 2

The information processing apparatus according to the configuration example 1, wherein the hardware processors are configured to train a probability model configured to forecast a probability that the visibility value is the first visibility value, the probability model being trained by inputting the at least one explanatory variable by using the training data sets.

### Configuration Example 3

The information processing apparatus according to the configuration example 1 or 2, wherein the hardware processors are configured to select at least one first candidate that affects forecasting of the visibility values from among candidates for the at least one explanatory variable, and generate the training data sets including the at least one first candidate selected as the at least one explanatory variable.

### Configuration Example 4

The information processing apparatus according to the configuration example 3, wherein the hardware processors are configured to select the at least one first candidate that enables a model configured to forecast the visibility value by using the candidates as an explanatory variable to perform forecasting with higher accuracy than the candidates other than the at least one first candidate.

### Configuration Example 5

The information processing apparatus according to the configuration example 3, wherein the hardware processors are configured to select the at least one first candidate having a higher cross-correlation with the visibility value than the candidates other than the at least one first candidate.

### Configuration Example 6

The information processing apparatus according to any one of the configuration examples 1 to 5, wherein the at least one explanatory variable includes at least one of relative humidity, temperature, or PM2.5.

### Configuration Example 7

The information processing apparatus according to any one of the configuration examples 1 to 6, wherein the m determination methods include a second determination method of determining the weights by using kernel density estimation.

### Configuration Example 8

The information processing apparatus according to any one of the configuration examples 1 to 7, wherein the hardware processors are configured to forecast the m visibility values for the at least one explanatory variable for forecasting by using the m forecast models, and calculate forecast values of the visibility values by using the m visibility values.

### Configuration Example 9

The information processing apparatus according to the configuration example 8, wherein the hardware processors are configured to, by inputting the at least one explanatory variable and by using a probability model configured to forecast a probability that the visibility value is the first visibility value, calculate the probability for the explanatory variable for forecasting, and calculate forecast values of the visibility values by using the calculated probability and the m visibility values.

### Configuration Example 10

An information processing apparatus comprising
one or more hardware processors configured to:
   forecast m visibility values (m is an integer larger than or equal to 2) for at least one explanatory variable by using m forecast models forecasting the visibility values as objective variables by inputting the at least one explanatory variable; and
   calculate forecast values of the m visibility values by using the visibility values, wherein
the m forecast models are trained by using training data sets each including the at least one explanatory variable and the visibility values, the training data set being assigned with weights determined by m mutually different determination methods, and
the m determination methods determine the weights for the visibility values included in the training data sets, and include a first determination method of determining to assign a larger weight to the training data set including a first visibility value than to other visibility values, the first visibility value occurring with lower frequency than the other visibility values.

### Configuration Example 11

An information processing method implemented by a computer, the method comprising:
determining weights by m mutually different determination methods (m is an integer more than or equal to 2), each determination method being a method using training data sets, each set including at least one explanatory variable and a visibility value as an objective variable, to determine the weights for the visibility values included in the training data sets, the m determination methods including a first determination method of determining to assign a larger weight to the training data set including a first visibility value than to other visibility values, the first visibility value occurring with lower frequency than the other visibility values; and
training m forecast models configured to forecast the visibility values by inputting the at least one explanatory variable, the m forecast models being trained by using the training data sets assigned with the weights determined by the m determination methods.

### Configuration Example 12

A computer program product comprising a non-transitory computer-readable recording medium on which a computer program executable by a computer is recorded, the computer program instructing the computer to perform processing, the processing including:
determining weights by m mutually different determination methods (m is an integer more than or equal to 2), each determination method being a method using training data sets, each set including at least one explanatory variable and a visibility value as an objective variable, to determine the weights for the visibility values included in the training data sets, the m determination methods including a first determination method of determining to assign a larger weight to the training data set including a first visibility value than to other visibility values, the first visibility value occurring with lower frequency than the other visibility values; and
training m forecast models configured to forecast the visibility values by inputting the at least one explanatory variable, the m forecast models being trained by using the training data sets assigned with the weights determined by the m determination methods.

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising
one or more hardware processors configured to:
determine weights by m mutually different determination methods, m being an integer more than or equal to 2, each determination method being a method using training data sets, each set including at least one explanatory variable and a visibility value as an objective variable, to determine the weights for the visibility values included in the training data sets, the m determination methods including a first determination method of determining to assign a larger weight to the training data set including a first visibility value than to other visibility values, the first visibility value occurring with lower frequency than the other visibility values; and
train m forecast models configured to forecast the visibility values by inputting the at least one explanatory variable, the m forecast models being trained by using the training data sets assigned with the weights determined by the m determination methods.

2. The information processing apparatus according to claim 1, wherein the hardware processors are configured to train a probability model configured to forecast a probability that the visibility value is the first visibility value, the probability model being trained by inputting the at least one explanatory variable by using the training data sets.

3. The information processing apparatus according to claim 1, wherein the hardware processors are configured to
select at least one first candidate that affects forecasting of the visibility values from among candidates for the at least one explanatory variable, and
generate the training data sets including the at least one first candidate selected as the at least one explanatory variable.

4. The information processing apparatus according to claim 3, wherein the hardware processors are configured to select the at least one first candidate that enables a model configured to forecast the visibility value by using the candidates as an explanatory variable to perform forecasting with higher accuracy than the candidates other than the at least one first candidate.

5. The information processing apparatus according to claim 3, wherein the hardware processors are configured to select the at least one first candidate having a higher cross-correlation with the visibility value than the candidates other than the at least one first candidate.

6. The information processing apparatus according to claim 1, wherein the at least one explanatory variable includes at least one of relative humidity, temperature, or PM2.5.

7. The information processing apparatus according to claim 1, wherein the m determination methods include a second determination method of determining the weights by using kernel density estimation.

8. The information processing apparatus according to claim 1, wherein the hardware processors are configured to
forecast the m visibility values for the at least one explanatory variable for forecasting by using the m forecast models, and
calculate forecast values of the visibility values by using the m visibility values.

9. The information processing apparatus according to claim 8, wherein the hardware processors are configured to,
by inputting the at least one explanatory variable and by using a probability model configured to forecast a probability that the visibility value is the first visibility value, calculate the probability for the explanatory variable for forecasting, and
calculate forecast values of the visibility values by using the calculated probability and the m visibility values.

10. An information processing apparatus comprising
one or more hardware processors configured to:
forecast m visibility values for at least one explanatory variable by using m forecast models forecasting the visibility values as objective variables by inputting the at least one explanatory variable, m being an integer larger than or equal to 2; and
calculate forecast values of the m visibility values by using the visibility values, wherein
the m forecast models are trained by using training data sets each including the at least one explanatory variable and the visibility values, the training data set being assigned with weights determined by m mutually different determination methods, and
the m determination methods determine the weights for the visibility values included in the training data sets, and include a first determination method of determining to assign a larger weight to the training data set including a first visibility value than to other visibility values, the first visibility value occurring with lower frequency than the other visibility values.

11. An information processing method implemented by a computer, the method comprising:
determining weights by m mutually different determination methods, m being an integer more than or equal to 2, each determination method being a method using training data sets, each set including at least one explanatory variable and a visibility value as an objective variable, to determine the weights for the visibility values included in the training data sets, the m determination methods including a first determination method of determining to assign a larger weight to the training data set including a first visibility value than to other visibility values, the first visibility value occurring with lower frequency than the other visibility values; and
training m forecast models configured to forecast the visibility values by inputting the at least one explanatory variable, the m forecast models being trained by using the training data sets assigned with the weights determined by the m determination methods.

12. A computer program product comprising a non-transitory computer-readable recording medium on which a computer program executable by a computer is recorded, the computer program instructing the computer to perform processing, the processing including:
determining weights by m mutually different determination methods, m being an integer more than or equal to 2, each determination method being a method using training data sets, each set including at least one explanatory variable and a visibility value as an objective variable, to determine the weights for the visibility values included in the training data sets, the m determination methods including a first determination method of determining to assign a larger weight to the training data set including a first visibility value than to other visibility values, the first visibility value occurring with lower frequency than the other visibility values; and
training m forecast models configured to forecast the visibility values by inputting the at least one explanatory variable, the m forecast models being trained by using the training data sets assigned with the weights determined by the m determination methods.
